(19) United States
(12) Patent Application Publication
(10) Pub. No.: US 2024/0405642 A1
(43) Pub. Date: Dec. 5, 2024

(54) ELECTRIC ROTARY TRANSFORMER

(71) Applicant: MAHLE International GmbH, Stuttgart (DE)

(72) Inventors: Florian Osdoba, Stuttgart (DE); Penyo Topalov, Stuttgart (DE); Philipp Zimmerschied, Stuttgart (DE)

(21) Appl. No.: 18/700,701

(22) PCT Filed: Oct. 11, 2022
(86) PCT No.: PCT/EP2022/078213

§ 371 Date: Apr. 11, 2024

(30) Foreign Application Priority Data
Oct. 12, 2021 (DE) 10 2021 211 474.1

(51) Int. Cl. H02K 11/042

(52) U.S. Cl. CPC H02K 11/042

(57) ABSTRACT

An electric rotary transformer for inductive energy transmission is disclosed. The rotary transformer includes a rotary transformer stator including a transformer primary coil and a rotary transformer rotor, rotatable during operation relative to the rotary transformer stator about an axially running rotation axis, including a transformer secondary coil. The transformer secondary coil and the transformer primary coil interact inductively during operation for generating a transformer voltage in the transformer secondary coil. The transformer secondary coil and/or the transformer primary coil has at least one electric conductor, through which a flow path of a fluid is guided. During operation a fluid flows along the flow path and cools the rotary transformer.

### CROSS-REFERENCE TO RELATED APPLICATIONS

This application claims priority to International Patent Application No. PCT/EP2022/078213 filed Oct. 11, 2022, which also claims priority to German Patent Application DE 10 2021 211 474.1 filed Oct. 12, 2021, the contents of each of which is hereby incorporated by reference in its entirety.

### TECHNICAL FIELD

The present invention relates to an electric rotary transformer for inductive energy transmission in particular in a separately excited electric synchronous machine. The invention additionally relates to a separately excited electric synchronous machine comprising such a rotary transformer. In addition, the invention relates to a motor vehicle with such a synchronous machine and the use of such a synchronous machine as traction motor.

### BACKGROUND

An electric rotary transformer is used for inductive energy transmission. For this purpose, the rotary transformer has a primary coil and a secondary coil. The primary coil is usually stationary, whereas the secondary coil is movable, in particular rotatable, relative to the primary coil. For this purpose, such a rotary transformer usually has a stationary stator and a rotor, rotatable relative to the stator about a rotation axis. The stator of the rotary transformer, also designated below as rotary transformer stator, usually has the primary coil, which is also designated below as transformer primary coil. The rotor of the rotary transformer, also designated below as rotary transformer rotor, usually has the secondary coil, which is also designated below as transformer secondary coil. During operation of the rotary transformer, the transformer primary coil induces a voltage in the transformer secondary coil. In so doing, heat can occur during operation.

Such a rotary transformer is used in particular in a separately excited electric synchronous machine. The separately excited electric synchronous machine has a stationary stator and a rotor, rotating relative to the stator about a rotation axis during operation, which are also designated below as machine stator and machine rotor. Here, a magnetic rotor field of the machine rotor and magnetic stator field of the machine stator interact. In the separately excited electric synchronous machine, the required rotor field of the machine rotor is separately excited. For this purpose, the machine rotor generally has a rotor coil which is supplied with a direct voltage for generating the magnetic field. The supply of the rotor coil can take place by means of the rotary transformer.

Such a synchronous motor with a rotary transformer is known for example from EP 2 869 316 B1.

The present invention is concerned with the problem of indicating, for a rotary transformer of the type mentioned in the introduction and for a separately excited electric synchronous machine with such a rotary transformer and for a motor vehicle with such a synchronous machine, improved or at least different embodiments which eliminate disadvantages from the prior art of known solutions. In particular, the present invention is concerned with the problem of indicating, for the rotary transformer and for the separately excited electric synchronous machine and for the motor vehicle, embodiments which are distinguished by an increased efficiency.

This problem is solved according to the invention by the subjects of the independent claim(s). Advantageous embodiments are the subject of the dependent claims.

### SUMMARY

The present invention is based accordingly on the general idea of providing at least one coil of an electric rotary transformer for inductive energy transmission with an electric conductor through which a flow path of a fluid for the cooling of the coil and thus of the rotary transformer is guided. Thus, a dissipating of the heat occurring during operation of the rotary transformer is brought about. Consequently, impairments and damage to the rotary transformer, due to the heat, are prevented or at least reduced. Furthermore, an increased efficiency of the rotary transformer is brought about in this way. Through the cooling of the coil and thus of the rotary transformer by means of the conductor, furthermore a compact configuration of the rotary transformer and an increased efficiency of the cooling is provided.

According to the idea of the invention, the electric rotary transformer for inductive energy transmission has a primary coil and a secondary coil, which are also designated below as transformer primary coil and transformer secondary coil. In addition, the rotary transformer has a stationary stator, also designated below as rotary transformer stator, and a rotor, also designated below as rotary transformer rotor. The rotary transformer stator has the transformer primary coil. The rotary transformer rotor has the transformer secondary coil. The rotary transformer rotor is rotatable relative to the rotary transformer stator about an axially running rotation axis. During operation, the rotary transformer rotor thus rotates relative to the rotary transformer stator about the rotation axis. For inductive energy transmission, and thus during operation, the transformer primary coil and the transformer secondary coil interact inductively for generating an electric voltage in the transformer secondary coil, wherein the voltage is also designated below as transformer voltage. At least one of the coils, therefore the transformer primary coil and/or the transformer secondary col, has at least one electric conductor, through which a flow path of a fluid is guided. During operation, the fluid flows here along the flow path and thus cools the coil and, consequently, the rotary transformer.

The directions indicated here refer to the axially running rotation axis. Accordingly, “axially” runs parallel, in particular coaxially, to the rotation axis. In addition, “radially” runs transversely to the rotation axis.

Advantageously, the transformer secondary coil and the transformer primary coil are arranged lying axially opposite. A more efficient induction of the transformer voltage in the transformer secondary coil therefore occurs.

At least one of the at least one electric conductors can be configured in a hollow manner, therefore as a hollow conductor, therefore can surround a cavity which is able to be flowed through, through which the flow path is guided.

At least one of the at least one electric conductors can be configured as a braid through which the flow path is guided. For electric conducting, the braid has several electrically conductive wires, therefore individual wires.

Advantageously, the braid has an outer casing in which the individual wires are arranged, and through which the flow path is guided. The outer casing is expediently electrically insulating, for example is an electrically insulating plastic.

The conductor, in particular the braid, advantageously has a cavity through which the flow path is guided. The cavity preferably runs within the outer casing of the braid.

The cavity is preferably formed centrally in the conductor, in particular centrally in the braid. This leads to a uniform and improved cooling of the braid and thus of the rotary transformer.

The fluid can basically be any fluid, in so far as a cooling of the associated coil takes place by means of the fluid. The fluid can be a gas or a liquid.

The flow path is preferably sealed electrically with respect to the individual wires.

Basically, it is conceivable to provide both the transformer primary coil and also the transformer secondary coil with at least one such electric conductor, through which a flow path is guided.

In advantageous embodiments, the transformer primary coil has at least one such electric conductor and is preferably configured as a flat coil. The at least one electric conductor is thus stationary in the rotary transformer. Consequently, a simplified configuration and improved cooling of the rotary transformer is brought about.

Preferably, at least one such conductor forms the transformer primary coil.

When the transformer secondary coil has such a conductor, it is preferred if the at least one conductor is embedded and/or received in a carrier, preferably made of plastic. This leads to an increased mechanical stability of the transformer secondary coil on rotations about the rotation axis and permits increased rotation speeds.

Advantageously, the rotary transformer rotor has a conductor plate which is provided with the transformer secondary coil. A simple configuration of the rotary transformer rotor and a simple and precise mounting and arrangement of the transformer secondary coil is thus brought about.

Embodiments are preferred in which the transformer secondary coil has at least one conductor track of the conductor plate, which is also designated below as transformer conductor track. This leads to a simplified configuration and production of the rotary transformer. Furthermore, the transformer secondary coil is configured in a simplified manner in this way and/or is stabilized mechanically by means of the conductor plate.

It is particularly preferred here if the transformer secondary coil is formed by at least one transformer conductor track of the conductor plate, therefore consists of at least one transformer conductor track of the conductor plate.

The conductor plate is advantageously configured in an axially flat manner. The conductor plate is thus also suitable for increased rotational speeds about the rotation axis.

Particularly preferably, the conductor plate is round in axial top view, for example is configured as a disc or as a ring. In this way, in particular an imbalance caused by the conductor plate is prevented or at least reduced.

The respective at least one transformer conductor track can be arranged on the conductor plate and can thus be visually perceptible from the exterior, or surrounded within the conductor plate and thus not visually perceptible from the exterior. Of course, embodiments are possible in which both at least one conductor path is arranged on the conductor plate and at least one conductor path is arranged within the conductor plate. The conductor plate can therefore also be configured in particular as a conductor plate known to the specialist in the art as a “multilayer circuit board”.

The transformer secondary coil can have at least two transformer conductor tracks spaced apart from one another axially. The transformer conductor tracks preferably run parallel to one another here.

Expediently, the transformer secondary coil runs surrounding the rotation axis, in particular in a spiral-shaped manner. In particular, the transformer secondary coil is configured as a planar winding.

Embodiments are considered advantageous in which the transformer coils are arranged in a magnet core which is fixed with respect to the rotary transformer. An improved inductive interaction of the transformer coils with one another is thus brought about. The magnet core, also designated below as transformer magnet core, can basically be configured in any desired manner. In particular, the magnet core concerns a ferrite body.

The transformer magnet core advantageously has an axially open recess for the transformer primary coil.

Advantageously, the transformer magnet core is open radially, so that the transformer secondary coil, in particular the conductor plate, penetrates radially into the transformer magnet core and is rotatable in the transformer magnet core.

In preferred embodiments, at least one of the at least one conductors is arranged in the magnet core. The rotary transformer can thus be produced in a simplified manner and, at the same time, the magnet core can be cooled by means of the at least one conductor. In addition, in this way an advantageous heat-transferring connection of the at least one conductor with the magnet core is brought about. Consequently, the rotary transformer is cooled better and/or more effectively.

Embodiments are particularly preferred in which the transformer primary coil has at least one such conductor, in particular at least one such braid, and the at least one conductor is arranged, in particular received, in the magnet core.

In advantageous embodiments, a channel body is received in the cavity, which channel body delimits the flow path. Thus in particular a fluidic separation is achieved between the fluid and the individual wires of the braid or respectively the fluid and the hollow conductor.

The channel body can basically be configured in any desired manner.

The channel body is preferably electrically insulating. Thus, by means of the channel body, an electric separation is brought about of the fluid from the individual wires of the braid or respectively from the hollow conductor. In particular, the channel body is produced from plastic.

Embodiments are considered advantageous in which the channel body is configured as a flexible tube. The braid or respectively the hollow conductor as whole can thus be easily deformed. Consequently, in this way the associated coil can be produced in a simplified and precise manner.

Basically, the individual wires of the braid can be electrically contacted with one another within the braid, in particular can lie against one another. Preferably, in this case, the associated coil can be operated at low frequencies.

Advantageously, at least a portion of the individual wires of the braid is received in an electrically insulating casing. When the braid has an outer casing, the casings are arranged in the outer casing. Preferably, the respective individual wire is received in an associated such electrically insulating casing. The braid comes into use here with increasing operating frequencies of the associated coil. In particular, the braid concerns such a braid in the manner of a so-called “high frequency braid”. Electric interactions of the individual wires within the braid are thus prevented or at least reduced. Consequently, a more efficient induction of the transformer voltage is brought about.

The respective casing can basically be configured in any desired manner, in so far as it is electrically insulating.

Embodiments are preferred in which at least one of the casings, advantageously the respective casing, is a lacquer layer applied to the associated, at least one, individual wire. The braid can thus be produced in a simple manner, and the individual wires can be electrically insulating with respect to one another in a reliable manner.

The rotary transformer advantageously has fluidic connections for supplying the rotary transformer with the fluid. The rotary transformer therefore advantageously has an inlet for letting the fluid into the rotary transformer, and an outlet for letting the fluid out from the rotary transformer. The connections are fluidically connected to the at least one electric conductor such that the fluid flows along the flow path through the at least one electric conductor.

Alternatively or additionally, it is conceivable that at least one of the at least one electric conductors projects out from the rotary transformer and is thus supplied with the fluid.

The rotary transformer can have a rectifier circuit downstream of the transformer secondary coil. The transformer voltage, induced in the transformer secondary coil as alternating voltage, can thus be converted into a direct voltage and can be made available for an associated application.

The rotary transformer can have an inverter circuit upstream of the transformer primary coil. The alternating voltage required in operation for the transformer primary coil can thus originate from an electrical energy source which provides a direct voltage.

The rotary transformer is preferably used for inductive energy transmission in a separately excited electric synchronous machine, in particular in a separately excited electric synchronous motor.

The synchronous machine has a rotor with a rotor shaft, wherein the rotor is also designated below as machine rotor. The machine rotor has a coil, provided in a rotationally fixed manner on the rotor shaft, which coil is also designated below as machine rotor coil. During operation, on supplying with a direct voltage, the machine rotor coil generates a magnetic field which is also designated below as rotor field. The synchronous machine has, furthermore, a stationary stator, which is also designated below as machine stator. The machine stator has a coil which is also designated below as machine stator coil. During operation, the machine stator coil generates a magnetic field which is also designated below as stator field. During operation of the synchronous machine, the stator field interacts with the rotor field such that the machine rotor rotates about the axial rotation axis. Here, the rotary transformer stator is fixed with respect to the machine stator. In addition, the rotary transformer rotor is arranged on the machine rotor in a rotationally fixed manner. In particular, the rotary transformer rotor is connected to the rotor shaft in a rotationally fixed manner. The machine rotor coil is connected to the transformer secondary coil such that, during operation, the machine rotor coil is supplied with a direct voltage for generating the rotor field. For this purpose, a rectifier circuit is advantageously connected between the transformer secondary coil and the machine rotor coil, which rectifier circuit, as mentioned above, can be a component of the rotary transformer, in particular of the rotary transformer rotor.

Preferably, the rotary transformer, in particular the rotary transformer rotor, is arranged axially at the front face of the machine rotor. Particularly preferably, the rotary transformer is spaced apart with respect to the machine rotor coil and/or with respect to the machine stator coil. A prevention or at least a reduction of undesired interactions between the rotary transformer and the rotor field and/or the stator field is thus brought about.

The synchronous machine can basically be used in any desired applications.

In particular, the synchronous machine can be used as a traction motor.

The synchronous motor can also be used as a servomotor for adjusting an adjusting element, for example a valve and suchlike.

The synchronous machine is used in particular in a motor vehicle which can comprise a battery as energy source. The synchronous machine serves here in particular for the drive of the motor vehicle, therefore is a traction motor of the motor vehicle.

The synchronous machine, in particular the rotary transformer, is advantageously integrated in a cooling circuit, through which the fluid circulates during operation. This means that the flow path is guided through the rotary transformer and through the cooling circuit, such that the rotary transformer is cooled by means of the fluid.

In particular, the cooling circuit is a part of the associated application, for example of the motor vehicle. In the associated application, the cooling circuit can be used for cooling further components.

The cooling circuit expediently has a conveying facility for conveying the fluid through the cooling circuit, and a cooler for cooling the fluid.

It shall be understood that in addition to the rotary transformer, the separately excited electric synchronous machine and the motor vehicle and the use of the synchronous machine as traction motor respectively also belong to the handling of the present invention.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained more closely in the following description, wherein the same reference numbers refer to identical or similar or functionally identical components.

### BRIEF DESCRIPTION OF THE DRAWINGS

There are shown, respectively schematically,

FIG. 1 a section through a separately excited electric synchronous machine having an electric rotary transformer with an electric conductor, and an enlarged view of the conductor,

FIG. 2 a section through the conductor in another example embodiment,

FIG. 3 a highly simplified circuit diagram of a separately excited electric synchronous machine with the rotary transformer in a motor vehicle,

FIG. 4 an isometric view, partially in section, of a machine rotor of the separately excited electric synchronous machine with the rotary transformer,

FIG. 5 a highly simplified section through the separately excited electric synchronous machine.

### DETAILED DESCRIPTION

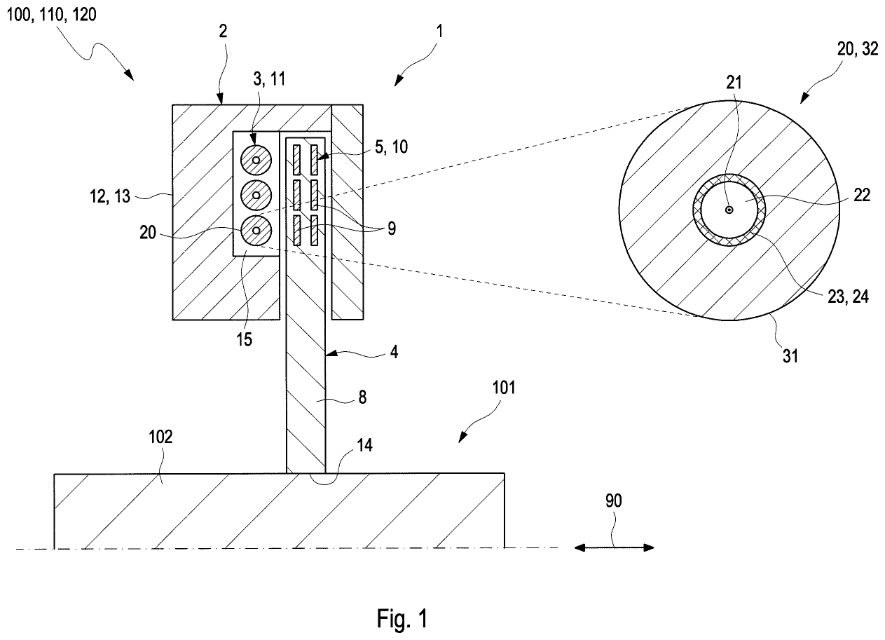

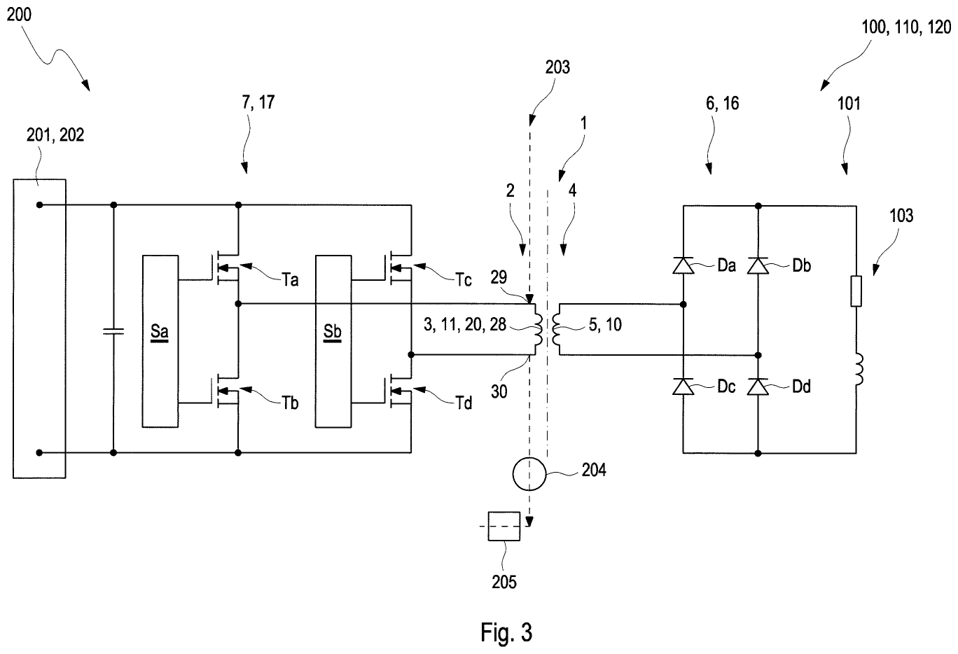

An electric rotary transformer 1, as is shown for example in FIGS. 1 and 3 and 4, is used as an inductive energy transmitter. The rotary transformer 1 can be used in a separately excited electric synchronous machine 100, shown in FIGS. 1 and 3 to 5. The rotary transformer 1 and/or the synchronous machine 100 can be used in a motor vehicle 200, as is shown in a highly simplified manner in FIG. 3. The separately excited electric synchronous machine 100 can be used as a synchronous motor 110, in particular for driving the motor vehicle 200. The synchronous machine 100 is therefore in particular a traction motor 120.

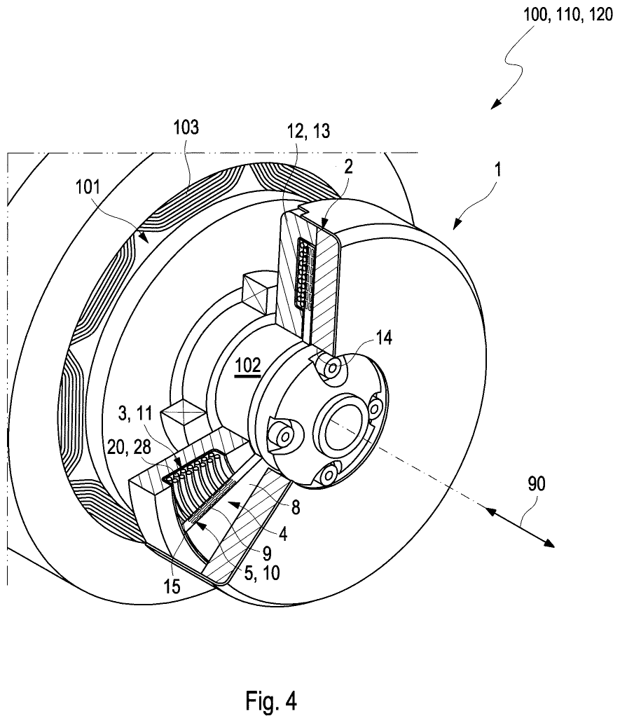

As can be seen from FIGS. 1 and 3 and 4, the rotary transformer 1 has a stator 2 and a rotor 4. The stator 2 is designated below as rotary transformer stator 2. The rotor 3 is designated below as rotary transformer rotor 4. The rotary transformer rotor 4 is rotatable relative to the rotary transformer stator 2 about an axially running rotation axis 90. During operation, the rotary transformer rotor 4 therefore rotates relative to the rotary transformer stator 2 about the rotation axis 90. For inductive energy transmission, the rotary transformer stator 2 has a primary coil 3, and the rotary transformer rotor 4 has a secondary coil 5. The primary coil 3 and the secondary coil 5, as can be seen from FIGS. 1 and 4, are arranged lying axially opposite in the example embodiments which are shown. During operation, the primary coil 3, which is also designated below as transformer primary coil 3, induces in the secondary coil 5, which is designated below as transformer secondary coil 5, an alternating voltage, which is also designated below as transformer voltage.

The directions which are indicated here refer to the rotation axis 90. Accordingly, “axially” runs parallel to the rotation axis. In addition, “radially” runs transversely to the rotation axis 90.

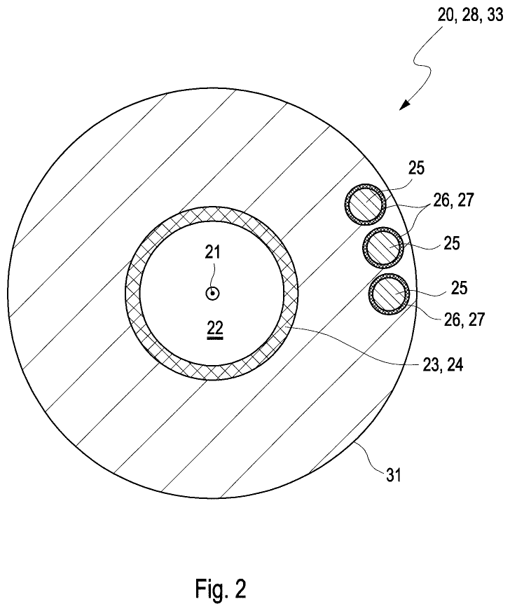

As can be seen in particular from FIGS. 1 and 2, at least one of the coils 3, 5 has at least one electric conductor 20, through which a flow path 21 of a fluid is guided. In the example embodiments which are shown, respectively one such electric conductor 20 is provided. Here, during operation, a fluid flows along the flow path 21 and thus cools the associated coil 3, 5 and consequently the rotary transformer 1. The 20 is also illustrated in an enlarged manner in FIG. 1. In addition, the conductor 20 is shown separately in FIG. 2.

In the example embodiments which are shown, the transformer primary coil 3 has such a conductor 20. In addition, in the example embodiments which are shown, the transformer primary coil 3 is configured as a flat coil 11. In particular, the transformer primary coil 3 is formed from the conductor 20.

As can be seen from FIG. 1, the rotary transformer rotor 4 in the example embodiments which are shown has a conductor plate 8 which is provided with the transformer secondary coil 5. The conductor plate 8 is configured in a disc-shaped manner and has a round shape, is therefore configured in the manner of a round disc or respectively of a ring. The transformer secondary coil 5 in the example embodiments which are shown has at least one conductor track 9 of the conductor plate 8, which is also designated below as transformer conductor track 9. In the example embodiments which are shown, the transformer secondary coil 5 consists of the at least one transformer conductor track 9 and is configured as a planar winding 10. As can be seen from FIG. 1, the conductor plate 8 can have two transformer conductor tracks 9, spaced apart axially with respect to one another, which surround the rotation axis 90 in a spiral-shaped manner. In addition, in the example embodiments which are shown, the at least one transformer conductor track 9 is arranged entirely in the conductor plate 8.

As can be seen from FIGS. 1 and 4, the transformer primary coil 3 and the transformer secondary coil 5 in the example embodiments which are shown are arranged in a magnet core 12, fixed with respect to the rotary transformer stator 2, in particular in a ferrite core 13. The magnet core 12 is also designated below as transformer magnet core 12. The transformer magnet core 12 is radially open, so that the conductor plate 8 penetrates with the transformer secondary coil 5 into the transformer magnet core 12 and is arranged rotatably therein. In addition, the transformer magnet core 12 has an axially open recess 15, in which the transformer primary coil 3, and thus the conductor 20, is arranged.

In the example embodiment shown in FIGS. 1 and 2, the conductor 20 is configured in a hollow manner and thus as a hollow conductor 32. The hollow conductor 32 has a central cavity 22, through which the flow path 21 is guided.

In the example embodiment shown in FIG. 2, the conductor 20 is configured as a braid 28. In the example embodiment which is shown, the braid 20 has a central cavity 22, through which the flow path 21 is guided.

In the example embodiments which are shown, an electrically and fluidically insulating channel body 23, preferably made of plastic, is received in the cavity 22. The channel body 23 delimits here the flow path 21 in the conductor 20 and thus in the hollow conductor 32 or respectively in the braid 28. In the example embodiments which are shown, the channel body 23 is also configured as a flexible tube 24.

For electrical conducting, the braid 28 has individual wires 25, which are only shown partially in FIG. 2. The individual wires 25 surround here the cavity 22 and the channel body 23. The individual wires 25 are therefore arranged on the side of the flow path 21 facing away from the channel body 23. As can be seen from FIGS. 1 and 2, the conductor 20 in the example embodiments which are shown has an electrically insulating outer casing 31. Here, in the case of the conductor 20 configured as braid 28, the individual wires 25 are received in the outer casing. In the example embodiment which is shown, the individual wires are therefore arranged between the channel body 23 and the outer casing 31.

According to FIG. 2, the braid 28 can have for at least a portion of the individual wires 25 an associated electrically insulating casing 26, in which the at least one associated individual wire 25 is received. The braid 28 is thus configured in the manner of a high frequency braid 33. The braid 28, configured in such a manner, is suitable here for the operation of the associated coil 3, 5 with increased frequencies. In the example embodiment of FIG. 2, the braid 28 has a casing 26 for the respective individual wire 25, in which casing the associated individual wire 25 is received. The respective casing 26 concerns here a lacquer layer 27.

As indicated in FIG. 3, in the example embodiments which are shown, the rotary transformer 1 has an inlet 29 for letting in the fluid into the braid 28, and an outlet 30 for letting the fluid out from the at least one braid 28.

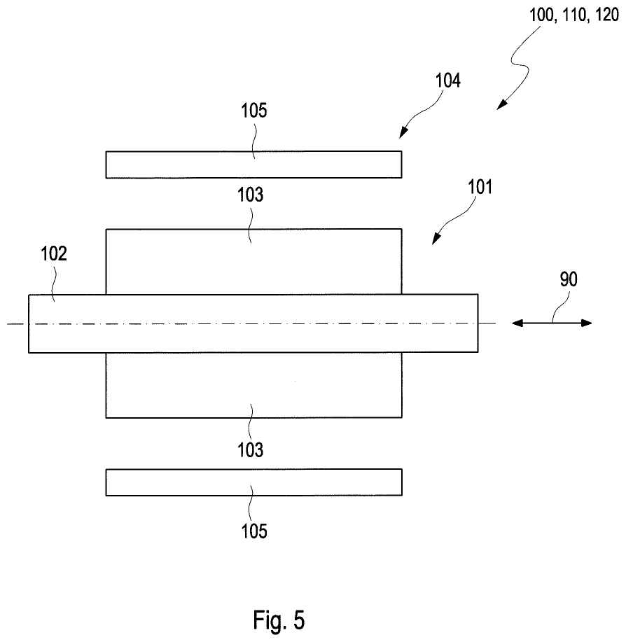

The separately excited electric synchronous machine 100, also abbreviated below as synchronous machine 100, has a rotor 101, as can be seen in particular from FIG. 4. The rotor 101 is also designated below as machine rotor 101. The machine rotor 101 has a rotor shaft 102 and a coil 103, provided in a rotationally fixed manner on the rotor shaft 102 (see FIGS. 3 to 5). The coil 103 is also designated below as machine rotor coil 103. The machine rotor coil 103 is symbolized in FIG. 3 as an inductance and an ohmic resistance. During operation, the machine rotor coil 103 generates a magnetic field which is also designated below as rotor field. The synchronous machine 100 has, furthermore, a stator 104, shown in FIG. 5, which is also designated below as machine stator 104. In addition, the synchronous machine 100 has a coil 105, fixed with respect to the machine stator 104 (see FIG. 5), which coil is also designated below as machine stator coil 105. During operation, the machine stator coil 105 generates a magnetic field which is also designated below as stator field. Stator field and rotor field interact here such that during operation the machine rotor 101 rotates about the rotation axis 90. To generate the rotor field, the machine rotor 101, in particular the machine rotor coil 103, requires a direct voltage and thus a direct current. In the example embodiments which are shown, this direct voltage of the machine rotor coil 103 is delivered by means of the transformer secondary coil 5 and thus by means of the rotary transformer 1. For this purpose, as can be seen from FIG. 3, a rectifier circuit 6 is connected between the transformer secondary coil 5 and the machine rotor coil 103, which rectifier circuit converts the transformer voltage into the direct voltage. In addition, for this purpose, as can be seen from FIGS. 1 and 4, the rotary transformer rotor 4 is arranged in a rotationally fixed manner on the rotor shaft 102 and thus on the machine rotor 101. The rotary transformer rotor 4 thus rotates during operation with the rotor shaft 102 and consequently with the machine rotor 101 about the rotation axis 90. In addition, the rotary transformer stator 2 is fixed with respect to the machine stator 104 and is thus stationary.

As can be seen further in particular from FIG. 4, in the example embodiments which are shown, the rotary transformer 1 is arranged at an axial front face of the machine rotor 101 and spaced apart with respect to the machine rotor coil 103 and to the machine stator coil 105. Of course, the synchronous machine 100 can also have two or more machine rotor coils 103 and/or two or more machine stator coils 105.

To induce the transformer voltage in the transformer secondary coil 5, the transformer primary coil 3 requires an alternating voltage or a clocked direct voltage, also designated below generally as alternating voltage. As can be seen from FIG. 3, the transformer primary coil 3 in the example embodiments which are shown is supplied via an electrical energy source 201, which provides a direct voltage. The energy source 201 in the example embodiments which are shown concerns a battery 202 of the motor vehicle 200. To supply the transformer primary coil 3 with the alternating voltage, an inverter circuit 7 is provided between the energy source 201 and the transformer primary coil 3. The inverter circuit 7 converts the direct voltage of the energy source 201 into the alternating voltage for the transformer primary coil 3. It is conceivable here that the inverter circuit 7 comprises a converter.

The rotationally fixed connection of the rotor shaft 102 to the rotary transformer rotor 4 in the example embodiments which are shown, as can be seen from FIGS. 1 and 4, is realized via a central opening 14 in the conductor plate 8, through which the rotor shaft 102 engages.

In the example embodiment shown in FIG. 3, the rectifier circuit 6 is configured, purely by way of example, as a bridge rectifier 16 with four diodes Da-d. In addition, the inverter circuit 7 is configured, purely by way of example, as a full bridge inverter 17, which has four transistors Ta-d and two driver switches Sa-b for the transistors Ta-d.

As can be seen from FIG. 3, the synchronous machine 100 is integrated in a cooling circuit 203, indicated in FIG. 3, so that during operation the fluid circulates along the flow path 21 in the cooling circuit 203. As shown in FIG. 3, the cooling circuit 203 has further components, such as for example a conveying facility 204 for conveying the fluid through the cooling circuit 203, and cooler 205 for cooling the fluid.

1. An electric rotary transformer for inductive energy transmission, comprising:
a rotary transformer stator including a transformer primary coil,
a rotary transformer rotor, rotatable during operation relative to the rotary transformer stator about an axially running rotation axis, the rotary transformer rotor include a transformer secondary coil,
wherein the transformer secondary coil and the transformer primary coil interact inductively during operation for generating a transformer voltage in the transformer secondary coil,
wherein at least one of the transformer secondary coil and the transformer primary coil has at least one electric conductor, through which a flow path of a fluid is guided, and
wherein during operation a fluid flows along the flow path and cools the rotary transformer.

2. The rotary transformer according to claim 1, wherein the transformer primary coil is flat coil and has the at least one electric conductor.

3. The rotary transformer according to claim 1, a magnet core in which the transformer primary coil and the transformer secondary coil are arranged,
wherein the at least one electric conductor is arranged in the magnet core.

4. The rotary transformer according to claim 1, wherein the at least one electric conductor has a central cavity, through which the flow path is guided.

5. The rotary transformer according to claim 4, wherein a channel body, received in the cavity, delimits the flow path.

6. The rotary transformer according to claim 5, wherein the channel body is a flexible tube.

7. The rotary transformer according to claim 1, wherein the at least one electric conductor is configured as a braid.

8. The rotary transformer according to claim 7, wherein the braid has individual wires, wherein at least a portion of the individual wires is received in an electrically insulating casing.

9. The rotary transformer according to claim 1, wherein the at least one electric conductor is configured as a hollow conductor.

10. The rotary transformer according to claim 1, further comprising an inlet for letting in the fluid into the at least one electric conductor configured as a braid and an outlet for letting the fluid out from the braid.

11. A separately excited electric synchronous machine, comprising:
a machine rotor including a rotor shaft and a machine rotor coil, provided in a rotationally fixed manner on the rotor shaft, the machine rotor coil generates a rotor field during operation,
a machine stator including a machine stator coil fixed with respect to the machine stator, the machine stator coil generates in operation a magnetic stator field that interacts with the rotor field such that the machine rotor during operation rotates about an axial rotation axis,
a rotary transformer, the rotary transformer including:
a rotary transformer stator including a transformer primary coil,
a rotary transformer rotor, rotatable during operation relative to the rotary transformer stator about an axially running rotation axis, the rotary transformer rotor include a transformer secondary coil,
wherein the transformer secondary coil and the transformer primary coil interact inductively during operation for generating a transformer voltage in the transformer secondary coil,
wherein at least one of the transformer secondary coil and the transformer primary coil has at least one electric conductor, through which a flow path of a fluid is guided, and wherein during operation a fluid flows along the flow path and cools the rotary transformer, wherein the rotary transformer stator is fixed with respect to the machine stator,
wherein the rotary transformer rotor is arranged on the machine rotor in a rotationally fixed manner, and
wherein the machine rotor coil is connected to the transformer secondary coil such that the machine rotor coil is supplied during operation with a direct voltage for generating the rotor field.

12. A motor vehicle, comprising:
a separately excited electric synchronous machine the separately excited electric synchronous machine including:
a machine rotor including a rotor shaft and a machine rotor coil, provided in a rotationally fixed manner on the rotor shaft, the machine rotor coil generates a rotor field during operation,
a machine stator including a machine stator coil fixed with respect to the machine stator, the machine stator coil generates in operation a magnetic stator field that interacts with the rotor field such that the machine rotor during operation rotates about an axial rotation axis,
a rotary transformer, the rotary transformer including:
a rotary transformer stator including a transformer primary coil,
a rotary transformer rotor, rotatable during operation relative to the rotary transformer stator about an axially running rotation axis, the rotary transformer rotor include a transformer secondary coil,
wherein the transformer secondary coil and the transformer primary coil interact inductively during operation for generating a transformer voltage in the transformer secondary coil,
wherein at least one of the transformer secondary coil and the transformer primary coil has at least one electric conductor, through which a flow path of a fluid is guided, and
wherein during operation a fluid flows along the flow path and cools the rotary transformer,
wherein the rotary transformer stator is fixed with respect to the machine stator,
wherein the rotary transformer rotor is arranged on the machine rotor in a rotationally fixed manner, and
wherein the machine rotor coil is connected to the transformer secondary coil such that the machine rotor coil is supplied during operation with a direct voltage for generating the rotor field; and
a cooling circuit, in which the synchronous machine is integrated, so that the fluid circulates along the flow path.

13. The motor vehicle according to claim 12, wherein during operation, the synchronous machine, as traction motor, drives the motor vehicle.

14. A traction motor comprising the separately excited synchronous machine according to claim 11.

15. The separately excited electric synchronous machine according to claim 11, wherein the transformer primary coil is a flat coil and has the at least one electric conductor.

16. The separately excited electric synchronous machine according to claim 11, wherein the rotary transformer further includes a magnet core in which the transformer primary coil and the transformer secondary coil are arranged, wherein the at least one electric conductor is arranged in the magnet core.

17. The separately excited electric synchronous machine according to claim 11, wherein the at least one electric conductor has a central cavity, through which the flow path is guided.

18. The separately excited electric synchronous machine according to claim 11, wherein the at least one electric conductor is configured as a braid.

19. The separately excited electric synchronous machine according to claim 18, wherein the braid has individual wires, wherein at least a portion of the individual wires is received in an electrically insulating lacquer layer.

20. The separately excited electric synchronous machine according to claim 18, wherein the rotary transformer further includes an inlet for letting in the fluid into the braid and an outlet for letting the fluid out from the braid.
